(19) United States
(12) Patent Application Publication
(10) Pub. No.: US 2026/0303898 A1
(43) Pub. Date: Oct. 1, 2026

(54) METHOD, APPARATUS, DEVICE AND STORAGE MEDIUM FOR PICTURE DISPLAY

(71) Applicant: Beijing Youzhuju Network Technology Co., Ltd., Beijing (CN)

(72) Inventors: Qiang Fu, Beijing (CN); Angxiang Fang, Beijing (CN)

(21) Appl. No.: 19/480,327

(22) PCT Filed: Aug. 16, 2024
(86) PCT No.: PCT/CN2024/112894

§ 371 Date: Oct. 30, 2025

(30) Foreign Application Priority Data
Aug. 18, 2023 (CN) 202311049185.0

(51) Int. Cl. H04N 21/431; H04N 21/472

(52) U.S. Cl. CPC H04N 21/4316; H04N 21/47202

(57) ABSTRACT

Embodiment of the disclosure discloses a method, apparatus, device and storage medium for picture display, including: displaying, in response to a video playback instruction, a video streaming picture in a video playback page; determining, in response to an invoking instruction of an application panel, a first display region and a second display region on the video playback page, where the first display region is configured to display the application panel, the second display region is configured to display a key picture region within the video streaming picture, and the key picture region is a partial image region in the video streaming picture.

This application claims the benefit of Chinese Patent Application No. 202311049185.0, entitled “METHOD, APPARATUS, DEVICE AND STORAGE MEDIUM FOR PICTURE DISPLAY” filed on Aug. 18, 2023, the entire content of which is incorporated herein by reference.

### FIELD

Embodiment of the present disclosure relates to the technical field of computers, and in particular to a method, apparatus, device and storage medium for picture display.

### BACKGROUND

In the current field of live streaming, the live streaming panel for live stream picture display often also contains other function controls that can be triggered, such as an information input control, a live streaming gift-related control, shopping list space, a live streaming duration display control, and the like.

In the existing implementations of live stream picture display, after triggering a function control on the live streaming panel, the function panel corresponding to the function control is presented directly on the layer of the live streaming panel. In such a presentation mode, the function panels obscure the live stream picture content on the original live streaming panel, thereby affecting the live streaming viewing experience.

### SUMMARY

Embodiment of the present disclosure provides a method, apparatus, device and storage medium for picture display, for effectively displaying a partial image region of an object displayed by a video picture when there is an obstruction on a video playback page.

According to a first aspect, an embodiment of the present disclosure provides a method of picture display, and the method includes: displaying, in response to a video playback instruction, a video streaming picture in a video playback page; determining, in response to an invoking instruction of an application panel, a first display region and a second display region on the video playback page, where the first display region is configured to display the application panel, the second display region is configured to display a key picture region within the video streaming picture, and the key picture region is a partial image region in the video streaming picture.

According to a second aspect, an embodiment of the present disclosure further provides an apparatus for picture display, including: a first display module configured to display, in response to a video playback instruction, a video streaming picture in a video playback page; a second display module configured to determine, in response to an invoking instruction of an application panel, a first display region and a second display region on the video playback page, where the first display region is configured to display the application panel, the second display region is configured to display a key picture region within the video streaming picture, and the key picture region within the video streaming picture is a partial image region of a target object displayed in the video streaming picture.

In a third aspect, an embodiment of the present disclosure further provides a computer device, including: one or more processors; a storage device for storing one or more programs, when the one or more programs are executed by the one or more processors, the one or more processors are caused to implement the method of picture display according to any one of embodiment of the present disclosure.

In a fourth aspect, an embodiment of the present disclosure further provides a computer-readable storage medium having a computer program stored thereon, which, when executed by a processor, implements the method of picture display according to any one of embodiment of the present disclosure.

### BRIEF DESCRIPTION OF DRAWINGS

In order to more clearly illustrate the technical solutions of the example embodiments of the present disclosure, a brief introduction is provided below for the accompanying drawings that will be needed to describe the embodiments. Obviously, the figures introduced are only some of the drawings for the embodiments to be described in the present disclosure, not all of them. For those skilled in the art, additional drawings can be obtained without the exercise of inventive effort based on these drawings.

FIG. 1 is a schematic flowchart of a method of picture display according to an embodiment of the present disclosure;

FIG. 2a illustrates an effect display diagram of a video streaming picture displayed only after the video playback page is invoked;

FIG. 2b illustrates a presentation effect diagram of a video streaming picture when an application panel is invoked after a video playback page in the prior art;

FIG. 2c illustrates a presentation effect diagram of a video streaming picture when an application panel is invoked after a video playback page by a method provided in this embodiment;

FIG. 2d illustrates an effect display diagram of a key picture region determined in a video streaming picture according to a method provided in this embodiment;

FIG. 2e shows an effect display diagram when an object-to-picture proportion is greater than a set threshold in a method provided in this embodiment;

FIG. 2f illustrates an effect display diagram of a video playback page when an object-to-picture proportion is greater than a set threshold in a method according to the embodiment;

FIG. 3 is a schematic structural diagram of an apparatus for picture display according to an embodiment of the present disclosure;

FIG. 4 is a schematic structural diagram of a computer device according to an embodiment of the present disclosure.

### DETAILED DESCRIPTION

Embodiments of the present disclosure will be described in more detail below with reference to the accompanying drawings. While certain embodiments of the present disclosure are shown in the drawings, it is to be understood that the present disclosure may be implemented in various forms, and should not be construed as limited to the embodiments set forth herein, and vice versa. It should be understood that the drawings and embodiments of the present disclosure are for example purposes only and are not intended to limit the scope of the present disclosure.

It should be understood that the steps recited in the method embodiments of the present disclosure may be performed in different orders, and/or in parallel. Further, the method embodiments may include additional steps and/or omit performing the illustrated steps. The scope of the present disclosure is not limited in this respect.

As used herein, the term “including” and variations thereof are open-ended, i.e., “including but not limited to”. The term “based on” is “based at least in part on”. The term “one embodiment” means “at least one embodiment”; the term “a further embodiment” means “at least one further embodiment”; the term “some embodiments” means “at least some embodiments”. The relevant definitions of other terms will be given below.

It should be noted that the concepts such as “first” and “second” mentioned in this disclosure are merely used to distinguish different apparatuses, modules, or units, and are not intended to limit the order of functions performed by the apparatuses, modules, or units or the mutual dependency relationship. It should be noted that the modification of “a” and “a plurality” mentioned in this disclosure is illustrative and not limiting, and those skilled in the art should understand that “one or more” should be understood unless the context clearly indicates otherwise.

The names of messages or information exchanged between a plurality of apparatuses in embodiments of the present disclosure are for illustrative purposes only and are not intended to limit the scope of such messages or information.

It would be appreciated that, before the technical solutions disclosed in embodiments of the present disclosure are used, the types of personal information related to the present disclosure, the usage scope, the usage scene and the like should be notified to the user in an appropriate manner according to the relevant laws and regulations and obtain the authorization of the user. In addition, in the acquisition and use of the object processing information, the user's personal information is not acquired or processed in a manner that does not reveal the user's identity.

For example, in response to receiving an active request from a user, prompt information is sent to the user to explicitly prompt the user that the requested operation will need to obtain and use the personal information of the user. Therefore, the user can autonomously select whether to provide personal information to software or hardware executing the operation of the technical solution of the present disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “disagree” to provide personal information to the electronic device.

It would be appreciated that the foregoing notification and obtaining a user authorization process is merely illustrative, and does not constitute a limitation on implementations of the present disclosure, and other manners of meeting related laws and regulations may also be applied to implementations of the present disclosure.

FIG. 1 is a schematic flowchart of a method of picture display according to an embodiment of the present disclosure. This embodiment can be applied to situations where there is an adaptive adjustment when there is an obstruction in the live streaming playback picture. The method can be performed by a picture display apparatus, and the apparatus may be implemented through software and/or hardware, and can be configured in a terminal and/or server to implement the method of picture display in the embodiments of the present disclosure.

It should be noted that an application scene of this embodiment may be described as: in a live streaming application that supports live streaming, a live streaming picture from a streamer side may be displayed through a live video playback page on a viewer side. With the continuous diversification of function items in the live streaming application, invoking controls of a plurality of function controls are presented on the video playback page for live streaming viewers to invoke other function items during the viewing process. Under the current display mechanism, the application panel of the invoked function item may be superimposed on the presented video playback page, causing obstruction to the live streaming picture in the video playback page. In some cases, the superimposed display obscure important content in the live streaming picture, thereby affecting the viewer's experience.

The method of picture display provided by the embodiment can effectively avoid the above problems caused in the existing picture display. Specifically, as shown in FIG. 1, the method of picture display provided in this embodiment may include steps S101 and S102.

At S101, a video streaming picture in a video playback page is displayed in response to a video playback instruction.

In this embodiment, the video playback page may be considered as a playback interface for playing a video streaming picture. When the application associated with the video playback page is a live streaming application, the video streaming picture displayed in the video playback page may be a live streaming picture forwarded and streamed from the streamer side. It should be noted that the scene in which the video playback page plays the video streaming picture in this embodiment may be any video playback scene, and this embodiment takes a live streaming scene as an example but is not limited to implementation in a live streaming scene.

In this embodiment, the video playback instruction may be generated by triggering a playback component or a playback link entry provided in the associated playback application software. This step may be responded to the video playback instruction. For example, using the live streaming application software installed on the viewer side as an example, the live streaming application software may include a plurality of live streaming link entries entering different streamer live streaming rooms, a video playback instruction corresponding to the live streaming room of the streamer may be generated by triggering any live streaming link entry. A video playback page corresponding to the live streaming room of the streamer may be displayed in response to the video playback instruction in this step, so as to play related live streaming pictures in the video playback page.

At S102, in response to an invoking instruction of an application panel, a first display region and a second display region are determined on the video playback page, where the first display region is configured to display the application panel, the second display region is configured to display a key picture region within the video streaming picture, and the key picture region is a partial image region in the video streaming picture.

In this embodiment, a further triggerable application function item may also be included in the video playback page invoked after the video playback instruction is responded to by the above steps. Still taking the live streaming application scene as an example, in the invoked video playback page, an application function item related to a further application involved in the live streaming process may be included, for example, a function item for triggering a gift-revenue panel may be included, the gift-revenue panel may be configured to display a gift received during the live streaming process. Alternatively, a function item for triggering a live streaming shopping-list panel may be included, and the live streaming shopping-list panel may be configured to provide a purchase channel for the product recommended by the streamer in the live streaming process. In addition, there is a functional item that trigger a further application panel, such as an information input function item, an online user display function items, and the like.

In this embodiment, the invoking instruction of the application panel associated with the application function item may be received through this step after triggering any application function item in the video playback page, and the video playback page is divided into the first display region and the second display region in response to the invoking instruction, and the invoked application panel may be displayed in the first display region and a key picture region in the second display region.

It may be known that the page size of the invoked video playback page and the panel size of the application panel may be predetermined. In a conventional case, the panel size of the application panel may be smaller than the page size of the video playback page. Therefore, in this embodiment, the video playback page may be divided into two display regions, and the divided first display region may be the same as the panel size of the application panel to display the invoked application panel. A region outside the first display region in the video playback page may be determined as the second display region.

It should be noted that, in this embodiment, the region positions of the first display region and the second display region in the video playback page are not specifically limited; nevertheless, it is preferable to divide, along the bottom border of the video playback page, a display region whose region size matches the panel size of the application panel so as to serve as the first display region, and to determine, within the video playback page, the region that is not occluded by the first display region as the second display region.

At the same time, it may be understood that, for displaying the first display region of the application panel, an original video streaming picture in the video playback page is occluded, and only the second display region is reserved to normally display the picture content of the video streaming picture. When displaying the video streaming picture in the second display region, the method provided by this embodiment is employed to determine a partial image region from the video streaming picture as the key picture region, and the key picture region is displayed within the second display region, thereby mitigating the impact of the application panel's occlusion of the video streaming picture.

In this embodiment, the key picture region may be considered as a partial image region determined from the video streaming picture. The region size of the partial image region may be the same as or smaller than the displayable size of the second display region, where the displayable size is smaller than an original picture size of the video streaming picture. For selecting the partial image region, feature recognition is performed on the video streaming picture, upon recognizing a follow object that the viewer follows in the video streaming picture, the image region occupied by the follow object within the video streaming picture is determined, and a partial image region is selected from the occupied image region.

It can be known that, in a video streaming picture displayed by a video playback page, not all picture content is key. A viewer tends to pay more follow to a dynamic object in a video streaming picture, such as a person or a pet, for example, a product object that the streamer is currently promoting for sale. his embodiment may take the object on which viewers follow more as the follow object, and thus may preferably select a partial image region from the image region where the follow object is located, and the selected partial image region is determined as the key picture region.

At the same time, the middle picture region of the video streaming picture is usually a region which the viewer follows; when feature recognition is performed on the video streaming picture and the follow object in which viewers followed is not recognized, an image region whose size is not greater than the second display region may be selected from the middle region of the video streaming picture as the partial image region.

In this embodiment, in order to achieve the display of the key picture region to the second display region, determination of the key picture region is required. In this embodiment, through the recognition result of the follow object that the viewer focuses on within the video streaming picture, when it is determined through the recognition result that the video streaming picture contains the follow object, the position of the follow object within the video streaming picture may be determined. According to the position information of the follow object in combination with the region size of the second display region, the partial image region corresponding to the follow object is selected from the video streaming picture, and the selected partial image region is designated as the key picture region, this embodiment can then display the key picture region within the second display region. Since the selected key picture region includes the partial picture content of the follow object, this embodiment in effect ensures the non-occluded playback of the partial image region of the follow object.

Continuing from the above description, when it is determined through the recognition result that the video streaming picture does not contain the follow object, the importance of the picture content presented in the video streaming picture may be regarded as essentially uniform. Accordingly, a partial image region consistent with the displayable size of the second display region may be selected within the video streaming picture, and the selected partial image region may be designated as the key picture region. In general, when this embodiment determines the key picture region is determined in this manner, any partial image region within the video streaming picture that matches the display able size may be selected as the key picture region. Considering that important picture content is often displayed in the middle area of the video playback page, this embodiment may preferably select, from the middle picture region of the video streaming picture, a partial image region consistent with the displayable size as the key picture region. In some embodiments, the middle picture region may be selected by a horizontal central axis of the video streaming picture.

In this embodiment, the determined key picture region may be displayed in the second display region either by shifting the playback position of the video streaming picture or by directly capturing the key picture region within the video streaming picture.

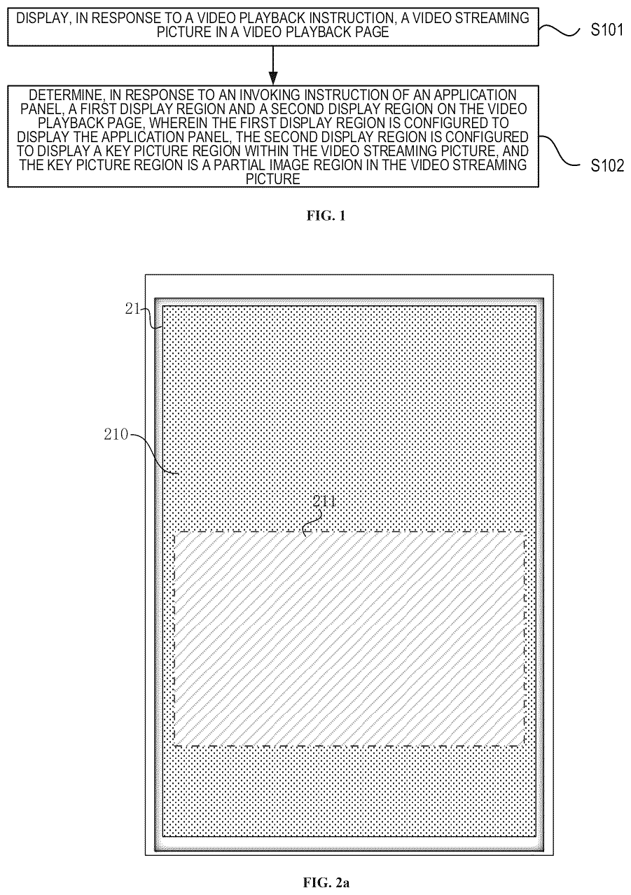

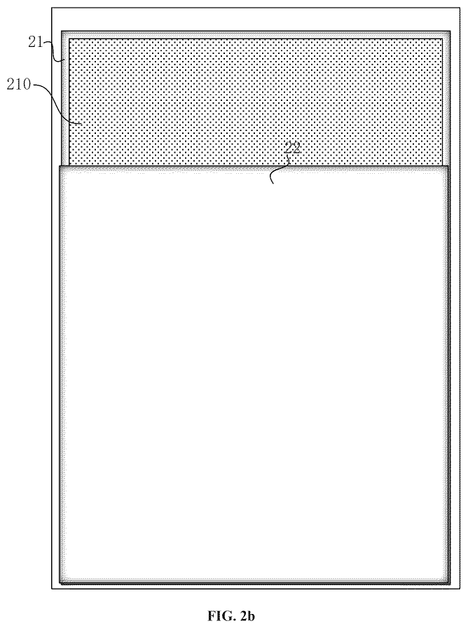

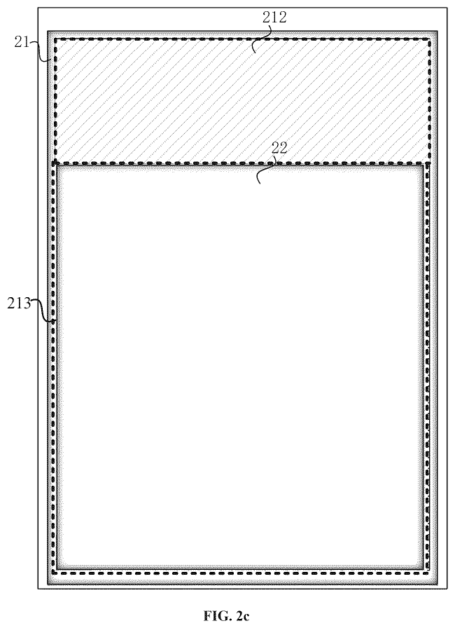

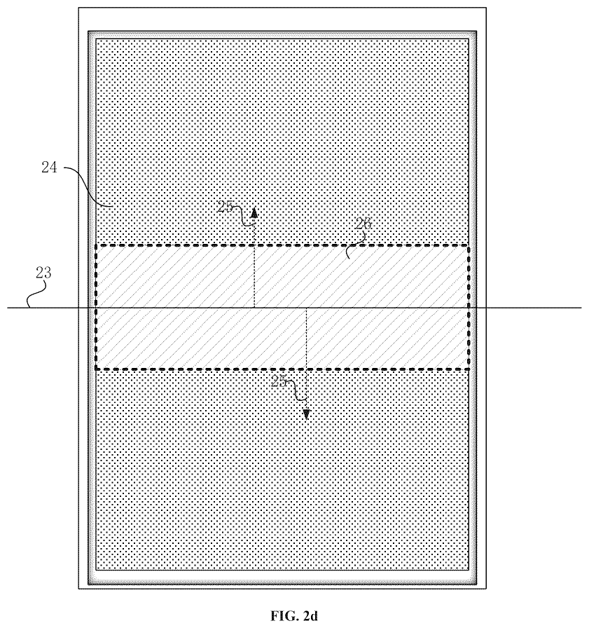

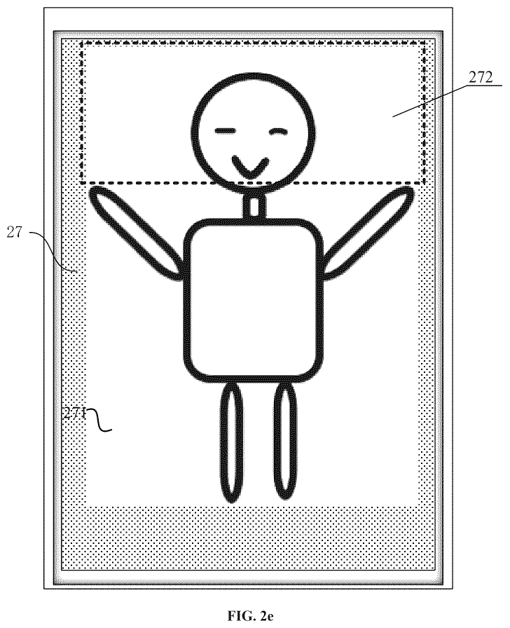

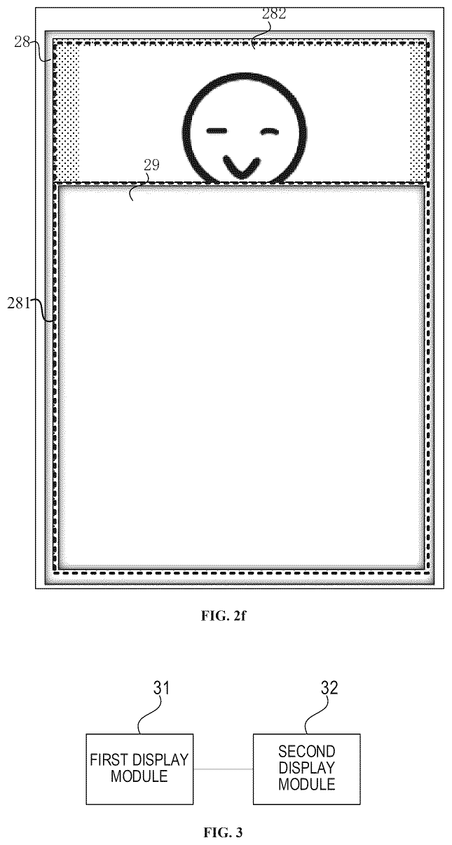

For example, to better understand an effect of the method provided in this embodiment in a video stream playback scene. FIG. 2a illustrates an effect display diagram of a video streaming picture displayed only after the video playback page is invoked. As shown in FIG. 2a, a video playback page 21 invoked after a certain playback application is started is displayed on a display screen. The page size of the video playback page 21 may be the same as or slightly smaller than the screen size of the display screen. A video streaming picture 210 is displayed within the video playback page 21, where a circled region 211 in the video streaming picture 210 may be considered as a region where an object which the viewer follows is located.

FIG. 2b illustrates a rendering effect diagram of a video streaming picture when an application panel is invoked after a video playback page in the prior art. As shown in FIG. 2b, an application panel 22 is superimposed on the video playback page 21. The application panel 22 occludes picture content in the video streaming picture 210, in particular occluding the picture content of the circled region 211 shown in FIG. 2a.

FIG. 2c illustrates a rendering effect diagram of a video streaming picture when the application panel is invoked after the video playback page by the method provided in this embodiment. As shown in FIG. 2c, the video playback page 21 is divided into a first display region 212 and a second display region 213 (bolded block portion), and the first display region 212 is configured to display the invoked application panel 22. According to the method provided in this embodiment, a partial image region may be determined from the circled region 211 shown in FIG. 2a as the key picture region of the video streaming picture, and the key picture region is adjusted to the second display region 213 for display, effectively alleviating the problem, in the prior art, that the invoked application panel occludes the key picture content in the video streaming picture.

The method of picture display provided in this embodiment can, during playback of the video streaming picture, respond to the invoked application panel and divide the video playback page into two display regions. The application content of the application panel is displayed in one display region, and the other display region displays the key picture region of the image region of the object displayed in the video stream. Compared with the prior art, the method better alleviates the problem that the invoked application panel occludes the key picture content of the video streaming picture in the video playback page, enables other operations to be performed in the application panel without affecting the viewer's observation of the key picture content of the video streaming picture, and further improves the user viewing experience of video streaming playback.

On the basis of the above embodiment, the step of determining the key picture region in the video streaming picture may be further optimized as steps a1) and b1).

a1) the playback scene associated with the video streaming picture is determined, and the target object is determined based on the playback scene.

In this embodiment, it can be seen from the above description that, in one implementation for determining the key picture region, the primary consideration is to locate the position of the follow object in the video streaming picture, so that the partial image region containing the follow object in the video streaming picture is determined as the key picture region. In this embodiment, the follow object that the viewer focuses on in the video streaming picture can be designated as a target object.

It should be noted that the playback scene associated with the video streaming picture displayed in the video playback page is often diversified; when the playback scene differs, the follow object that the viewer focuses on in the video streaming picture also differs. I Accordingly, this embodiment can determine different target objects in relation to the different playback scenes associated with the video streaming picture. This embodiment can first determine the playback scene associated with the video streaming picture and then determine the specific target object according to the playback scene.

This embodiment can determine in advance the playback scenes associated with the different video streaming pictures and, through this step, determine the target object corresponding to the playback scene associated with the video streaming picture.

It can be known that the viewer's f points of focus on the picture content presented in the video streaming picture differ under different playback scenes. For example, in a playback scene of item sales or product explanation, the viewer focuses more on the item being sold or the product being explained. In a performance-oriented playback scene centered on streamer performance, the viewer focuses more on the objects participating in the performance or creating entertainment, such as persons, pets, or virtual characters. This embodiment can, after determining the playback scene and in conjunction with the substantive content of the video streaming picture, determine the target object that matches the playback scene.

As one implementation, determining the playback scene associated with the video streaming picture and determining the target object according to the playback scene can be embodied as steps a11), a12), and a13).

a11) a playback scene associated with the video streaming picture is determined based on video attribute information of a video to which the video streaming picture pertains.

In this embodiment, the playback scene associated with the video streaming picture may be determined according to video attribute information of the played video, for example, tag information, title information, or other attributes of the video. For example, when the played video is a shopping live streaming, the playback scene associated with the video streaming picture is determined as a live shopping scene. For a further example, when the tag information of the played video is streamer performance or streamer show, the playback scene associated with the video streaming picture is determined as a live streaming performance scene.

a12) in accordance with the playback scene pertaining to a first type of playback scene, a first follow object set with respect to the first type of playback scene is determined as the target object.

In this embodiment, the playback scene associated with the video streaming picture may be generally divided into a first type of playback scene and a second type of playback scene. The first type of playback scene may be a scene including one or more activity objects, performing an activity display such as a performance, a rap, or a skill display. In this first type of playback scene, the participating object participating in the activity display may be set as a first follow object. It can be learned that the participating objects involved in different videos may be different. For example, in the foregoing given live streaming performance scene, the activity content mainly centers on participating objects such as persons or pets. The present embodiment may take the persons or objects participating in the live streaming performance as the first follow object under this live streaming performance scene, and preferably as the target object under this first type of playback scene.

In this embodiment, which participating object the video streaming picture corresponds to may be determined by analyzing attribute information related to the video streaming picture. In some embodiments, the attribute information may include key content of the video stream, video title, and video tag.

A13) in accordance with the playback scene pertaining to a second type of playback scene, a second follow object set with respect to the second type of playback scene is determined as the target object, where the first type of playback scene is different from the second type of playback scene.

In this embodiment, for the second type of playback scene in the playback scene, the scene may be one in which the items to be sold, the products to be explained, or the content to be explained are explained, demonstrated, or sold. The second type of playback scene may set the display objects currently being explained, demonstrated, or sold to the second follow object. Similarly, the display objects involved in different videos differ; for example, in an e-commerce shopping live streaming scene, the display objects may be the products to be sold that the streamer is explaining or functionally demonstrating, while in a teaching live streaming scene, the display objects may be the teaching courseware that the instructor is explaining. This embodiment may likewise determine, by analyzing attribute information related to the video streaming picture, which display object the video streaming picture specifically corresponds to.

In the foregoing technical solution of this embodiment, a specific implementation of the target object determination is given, and the determined target object may be configured to determine a subsequent key picture region.

b1) the partial image region is determined, based on a feature recognition result of the target object in the video streaming picture, from the video streaming picture as the key picture region.

In this embodiment, after the target object is determined through the foregoing steps, whether the target object exists in the video streaming picture may be determined by performing a feature recognition on the target object. It would be appreciated that, regardless of which type of playback scene, there is a situation that the target object may fail to appear in the video streaming picture, for example, in the first type of playback scene, the activity-participating object may participate only in audio form, while the person or other performing object itself does not appear on screen and no related picture is presented. For a further example, in the second type of playback scene, the object being sold or the content being explained may, due to capturing angle or other reasons, likewise not be concretely presented in the picture.

Based on this, this embodiment may perform a feature recognition of the target object on the video streaming picture to determine whether the target object is currently included in the video streaming picture, and may determine different determining manners of the key picture region by determining the recognition result of whether the target object feature includes or not in the video streaming picture.

With reference to the foregoing description, as one implementation, the determination of a partial image region from the video streaming picture as the key picture region based on the feature recognition result of the target object in the video streaming picture may be embodied as steps b11), b12), and b13).

b11) a feature recognition is performed on the target object in the video streaming picture.

In this embodiment, the feature recognition logic of the target object may be first performed by the execution of this step, and a corresponding recognition result may be determined. For example, an object feature matching the target object may be recognized in the video streaming picture; or an object feature matching the target object is not recognized in the video streaming picture. Through different recognition results, the following different key picture region determining steps may be performed.

b12) in accordance with the feature recognition result being that no object feature matching the target object is recognized, a first partial image region is selected from the video streaming picture based on a displayable size of the second display region, and determining the first partial image region as the key picture region.

In this embodiment, as long as the target object is not recognized from the video streaming picture, the key picture region may be determined by this step. It would be appreciated that, when the target object is not present in the video streaming picture, it may be considered that the key levels of different image regions of the video streaming picture may be regarded as essentially uniform; at this time, the present embodiment only needs to ensure that the selected partial image region can be displayed in the second display region.

Accordingly, this step selects, within the video streaming picture and based on a display able size of the second display region, an image region whose region size is not greater than the displayable size as the first partial image region, and determines the first partial image region as the key image region. It should be noted that, to maximize utilization of the display space of the second display region, this embodiment may select an image region whose region size matches the display able size as the first partial image region.

Further, considering the characteristic that the main content is often played at the center of the video playback page, that is, considering that the viewer's attention to the picture content at the middle playback position in the video streaming picture is higher than that at the two ends, this embodiment may also select an image region consistent with the displayable size from the middle playback position of the video streaming picture as the first partial image region.

Specifically, the optimization of selecting a first partial image region from the video streaming picture based on the display able size of the second display region and determining the first partial image region as the key picture region in this embodiment includes the following steps b121) and b122).

b121) a horizontal central axis of the video streaming picture is determined along a vertical direction of the video playback page.

In this embodiment, the vertical direction may be relative to the bottom and top of the video playback page, which may be considered as an extension direction of the straight line formed by connecting the bottom and top vertices of the video playback page. This step can determine a horizontal central axis that bisects the video streaming picture along this vertical direction, and the height of this horizontal central axis in the vertical direction can be considered as half of the picture height possessed by the video streaming picture.

b122) the first partial image region is selected, in the video streaming picture, with the horizontal central axis as a selected region symmetrical line and with the displayable size as a selected region size, and determining the selected first partial image region as the key picture region.

In this embodiment, the selected region symmetrical line may be understood as an axis center symmetrical line of an image region to be selected in the video streaming picture, and this step takes a horizontal central axis as the selected region symmetry line. Additionally, this step can also limit the selected region size of the image region to be selected to be the same as the display able size of the second display region. The image region selected through the above two limiting conditions can be determined as the first partial image region in the video streaming picture, and this step may designate this first partial image region as the key picture region.

For example, FIG. 2d illustrates an effect display diagram of a key picture region determined in a video streaming picture of the method provided in this embodiment. As shown in FIG. 2 d, a straight line 23 (not actually displayed in the video streaming picture) is the horizontal central axis in a video streaming picture region 24; and with the straight line 23 as the starting position for the demarcation, the image region can be demarcated in the video streaming picture along arrow directions of two dashed lines 25, and the size of the selected region is limited to be the same as the displayable size of the second display region. Thus, the first partial image region is formed and designated as a key picture region 26 in the video streaming picture.

The execution of the step b121) and the step b122) in this embodiment gives an implementation of determining the key picture region when the target object is not recognized. According to the key picture region determined in the step provided in this embodiment, it can be ensured that the picture content in the middle position of the video playback page in the video streaming picture is presented without occlusion in the second display region.

b13) in accordance with the feature recognition result being that an object feature matching the target object is recognized, a second partial image region of the target object is selected based on a picture proportion of the target object in the video streaming picture, and determining the second partial image region as the key picture region.

In this embodiment, this step may be determined as a step of determining a key picture region under a further recognition result of feature recognition of the target object. In this embodiment, after it is determined that the target object is present in the video streaming picture, the picture proportion of the target object in the video streaming picture may be further determined by this step. Subsequently, the key picture region may be specifically determined by the ratio of the picture proportion.

For example, when the ratio of the picture proportion is greater than or equal to a predetermined proportion threshold, it can be considered that the importance of the picture content throughout the entire video streaming picture is essentially uniform. Accordingly, the original picture region displayed in the video streaming picture and presented in the second display region can be directly determined as the second partial image region of the target object, and this second partial image region can be determined as the key picture region. Similarly, when the picture proportion is less than the proportion threshold, the image region occupied by the target object in the video streaming picture can be regarded as a candidate area for selecting the key picture region.

In an implementation, the second partial image region of the target object may be further selected based on a coordinate position (for example, the position where the top of the object is located) of the target object displayed in the candidate region to serve as the key picture region. For example, when the top position of the target object falls within a sub-region demarcated in the second display region, the original picture region displayed and presented in the second display region can be directly determined as the second partial image region of the target object. Alternatively, when the top position of the target object does not fall within the sub-region demarcated in the second display region, the second partial image region of the target object can be demarcated based on the center point of the target object in combination with the displayable size of the second display region, thereby forming the key picture region within the video streaming picture.

In this embodiment, the execution of the above steps b11) to b13) provides different implementations for determining the key picture region under different recognition results of the target object. The key picture region determined by the steps provided in this embodiment can better match the actual playback scene of the video streaming picture and can more effectively ensure the presentation of the content that the viewer wants to watch in the second display region.

With reference to the foregoing description, in an implementation, in this embodiment, a second partial image region of the target object may be selected based on a picture proportion of the target object in the video streaming picture, and the second partial image region is determined as the key picture region as the following steps b131), b132), and b133). b131) an object-to-picture proportion of the target object in the video streaming picture is determined.

In this embodiment, after the target object is recognized in the video streaming picture, the position information of the target object in the video streaming picture may be determined, and through this position information, the picture region occupied by the target object can be determined. This step can calculate the ratio of the aforementioned picture region to the picture region of the video streaming picture, thereby determining the object-to-picture proportion.

b132) in accordance with the object-to-picture proportion being greater than or equal to a first set threshold, a picture region in the video streaming picture that has already displayed in the second display region is determined as the second partial image region of the target object, and the second partial image region is determined as the key picture region.

In this embodiment, the first set threshold may be understood as an empirical value for comparing the ratio size of the object-to-picture proportion. In this step, when the object-to-picture proportion is greater than or equal to the first set threshold, the picture region of the video streaming picture that has been displayed in the second display region can be directly used as the second partial image region of the target object, and the second partial image region can be determined as the key picture region.

In this case, it may be considered that the target object occupies a large proportion in the entire video streaming picture. At this time, it is equivalent to that most of the content presented in the video streaming picture is relatively key. When the condition of this step is met, it is equivalent to not needing to adjust the picture content that has been presented in the second display region in the video streaming picture. The original picture region in the video streaming picture corresponding to the second display region can be regarded as the second partial image region of the target object, and the picture content presented in this second partial image region can be regarded as the picture content of the key picture region.

FIG. 2e illustrates an effect display diagram when an object-to-picture proportion is greater than a set threshold in the method provided in this embodiment. As shown in FIG. 2e, a video streaming picture 27 includes a target object 271. The target object 271 almost fills the entire video streaming picture 27, it may be considered that the ratio of the picture proportion of the target object 271 to the video streaming picture 27 is larger, and the actual value of the picture proportion may already exceed the set threshold.

For example, in the effect display case shown in FIG. 2e, FIG. 2f illustrates an effect display diagram on a video playback page when an object-to-picture proportion is greater than a set threshold in the method provided in this embodiment, as shown in FIG. 2f, a video playback page 28 includes a first display region 281 and a second display region 282, where an application panel 29 is shown in the first display region 281. For the second display region 282, in a scene where the picture proportion of the target object is greater than the set threshold as shown in FIG. 2e, the second display region 282 still displays the image region of the target object that was originally displayed in this second display region (this originally displayed image region is shown in FIG. 2e, equivalent to a partial picture region 272 of the target object shown in FIG. 2e). That is, the originally displayed image region is directly used as the second partial image region determined under the condition that the picture proportion is greater than the set threshold.

b133) in accordance with the picture proportion being less than the first set threshold, a key picture region in the video streaming picture is determined based on a second reference line set in the video streaming picture and in combination with object position information of the target object.

In this embodiment, if the picture proportion is less than the first set threshold, it can be considered that, in addition to the target object, the video streaming picture includes more regions presenting non-key picture content, such as background and other static pictures. In this case, the key picture region can be determined by this step.

For example, in the implementation of determining the key picture region in this step, the object position information of the target object may be obtained, which may include the center position information of the object center position of the target object and the top position information of the object top position of the target object. In addition, the determination of a reference line required for determination may be carried out within the video streaming picture. Specifically, this step may determine the reference line in the second display region, and the position of the reference line may be selected at a position half the height of the second display region or at a position at a set distance from the top of the second display region. In some embodiments, the reference line may also be considered as a straight line parallel to the horizontal direction of the video playback page.

As described above, after determining the reference line and obtaining the object position information, a closed display sub-region can be formed with the video streaming picture by the reference line and the top border of the second display region, as well as the left and right borders of the video streaming picture. In this embodiment, based on the object position information, the positional relationship between the target object and the display sub-region can be compared, and the key picture region can be specifically determined according to the comparison result. For example, when the top of the target object falls within the display sub-region, the original picture region of the video streaming picture in the second display region can be directly used as the second partial image region of the target object, and the second partial image region can be determined as the key picture region. When the top of the target object does not fall within the display sub-region, the key picture region can be further determined in combination with the center position of the target object and the display able size of the second display region.

In this embodiment, the execution of the step b131) to the step b133) gives an implementation of determining the key picture region when the target object is recognized from the video streaming picture. By means of the key picture region determined in the foregoing step provided in this embodiment, it can be ensured that the picture content corresponding to the target object in the video streaming picture is presented without occlusion in the second display region.

Continuing from the above description, as one implementation, in this embodiment, the selection of the second partial image region of the target object, based on the reference line set in the video streaming picture and in combination with the object position information of the target object, may be embodied as steps a2), b2), c2), and d2).

a2) a horizontal line at a distance of a second set threshold from a top border of the video streaming picture is determined, along a vertical direction of the video playback page, and determining the horizontal line as the reference line.

In this embodiment, this step may still determine the reference line through the video playback page, for example, by identifying a horizontal line at a distance of a second set threshold from the top border of the video streaming picture along the vertical direction of the video playback page. In some embodiments, the second set threshold can also be regarded as an empirical distance threshold or a height proportion threshold formed by combining the picture height of the video streaming picture with an empirical constant value.

The horizontal line formed by this step may be designated as the reference line of this embodiment. This embodiment can cache relevant information of the reference line within the video streaming picture, but it will not be directly presented in the video streaming picture.

b2) a closed display sub-region with the video streaming picture by the reference line and the top border, and an object top position and an object center position are extracted in the object position information.

This step provides for the determination of the display sub-region and the extraction of position information related to the object top position and the object center position. In this embodiment, the display sub-region may be determined as the closed region formed by the reference line, the top border, and the left and right borders of the video streaming picture.

It can be understood that the display sub-region formed is closer to the top end of the second display region. This embodiment may determine whether the object top position of the target object falls within the display sub-region and provide different steps for determining key image regions based on the determination result.

c2) in accordance with the object top position being within the display sub-region, the picture region is determined as the second partial image region of the target object.

In this embodiment, this step can be regarded as the step for determining the key picture region when the object top position is within the display sub-region. Specifically, when the object top position of the target object meets this determination result, it can be considered that most regions of the target object has already fallen into the second display region. Therefore, there is no need to adjust the content currently displayed in the second display region. The picture region of the video streaming picture that has been displayed in the second display region can be directly determined as the second partial image region of the target object.

d2) if the object top position is not in the video streaming picture in the display sub-region, selecting a second partial image region of the target object by taking the object center position as a selected region center point and taking the displayable size as a selected region size in the video streaming picture.

In this embodiment, this step may be regarded as the step of determining the key picture region when the top position of the object is not sub-display region. Specifically, when the object top position of the target object meets this determination result, it can be considered that the picture content of the video streaming picture displayed in the second display region does not include the key content of the target object. Therefore, it is necessary to adjust the image region to be displayed in the second display region according to the actual position of the target object. The region to be adjusted and displayed in the second display region can be the second partial image region of the target object. The second partial image region preferably comes from an image region formed by extending outward from the object center position, which serves as the selected region center point, to the display able size in the video streaming picture.

In the above technical solution of this embodiment, the implementation of the steps for determining the corresponding key picture region when the video streaming picture frame contains the target object and the picture proportion of the target object is less than the first set threshold is provided. The key picture region determined by the steps provided in this embodiment can better match the actual playback scene of the video streaming picture and can more effectively ensure the effective presentation of the content that the viewer wants to watch in the second display region.

FIG. 3 is a schematic structural diagram of an apparatus for picture display according to an embodiment of the present disclosure. This embodiment is applicable to the situation of adaptively adjusting the live streaming playback picture. The apparatus can be implemented through software and/or hardware and can be configured in a terminal and/or server to implement the method of picture display in the embodiments of this disclosure. The apparatus may specifically include: a first display module 31 and a second display module 32. The first display module 31 is configured to display, in response to a video playback instruction, a video streaming picture in a video playback page. The second display module 32 is configured to determine, in response to an invoking instruction of an application panel, a first display region and a second display region on the video playback page, where the first display region is configured to display the application panel, the second display region is configured to display a key picture region within the video streaming picture, and the key picture region within the video streaming picture is a partial image region of a target object displayed in the video streaming picture.

The apparatus for picture display provided in this embodiment can, during playback of the video streaming picture, respond to the invoked application panel and divide the video playback page into two display regions. The application content of the application panel is displayed in one display region, and the other display region displays the key picture region of the image region of the object displayed in the video stream. Compared with the prior art, the method better alleviates the problem that the invoked application panel occludes the key picture content of the video streaming picture in the video playback page, enables other operations to be performed in the application panel without affecting the viewer's observation of the key picture content of the video streaming picture, and further improves the user viewing experience of video streaming playback.

Further, the second display module 32 may specifically include: an object determining unit configured to a playback scene associated with the video streaming picture, and determine a target object based on the playback scene; and a key picture region determining unit configured to determine, based on a feature recognition result of the target object in the video streaming picture, the partial image region from the video streaming picture as the key picture region.

Further, the object determining unit may be specifically configured to: determine a playback scene associated with the video streaming picture based on video attribute information of a video to which the video streaming picture pertains; determine, in accordance with the playback scene pertaining to a first type of playback scene, a first follow object set with respect to the first type of playback scene as the target object; determine, in accordance with the playback scene pertaining to a second type of playback scene, a second follow object set with respect to the second type of playback scene as the target object; where the first type of playback scene is different from the second type of playback scene.

Further, the key picture region determining unit may specifically include: an recognizing sub-unit configured to perform a feature recognition on the target object in the video streaming picture; a first determining sub-unit configured to select, in accordance with the feature recognition result being that no object feature matching the target object is recognized, a first partial image region from the video streaming picture based on a display able size of the second display region, and determining the first partial image region as the key picture region; and a second determining sub-unit configured to select, in accordance with the feature recognition result being that an object feature matching the target object is recognized, a second partial image region of the target object based on a picture proportion of the target object in the video streaming picture, and determining the second partial image region as the key picture region.

Further, the first determining sub-unit may be specifically configured to: determine a horizontal central axis of the video streaming picture along a vertical direction of the video playback page; and select, in the video streaming picture, the first partial image region with the horizontal central axis as a selected region symmetrical line and with the display able size as a selected region size, and determining the selected first partial image region as the key picture region.

Further, the second determining sub-unit may be specifically configured to: determine an object-to-picture proportion of the target object in the video streaming picture; determine, in accordance with the object-to-picture proportion being greater than or equal to a first set threshold, a picture region in the video streaming picture that has already displayed in the second display region as the second partial image region of the target object, and determining the second partial image region as the key picture region; select, in accordance with the picture proportion being less than the first set threshold, the second partial image region of the target object based on a reference line set in the video streaming picture and in combination with object position information of the target object, and determining the second partial image region as the key picture region.

Further, the step of selecting the second partial image region of the target object based on the reference line set in the video streaming picture and in combination with object position information of the target object includes: determining, along a vertical direction of the video playback page, a horizontal line at a distance of a second set threshold from a top border of the video streaming picture, and determining the horizontal line as the reference line; forming a closed display sub-region with the video streaming picture by the reference line and the top border, and extracting an object top position and an object center position in the object position information; determining, in accordance with the object top position being within the display sub-region, the picture region as the second partial image region of the target object; otherwise, selecting, in the video streaming picture, the second partial image region of the target object with the object center position as a selected region center point and with the displayable size as a selected region size.

The foregoing apparatus is capable of executing the method provided by any embodiment of this disclosure, and possesses the corresponding functional modules and beneficial effects for executing the method.

It should be noted that various units and modules included in the above apparatus are only divided according to the function logic, but are not limited to the foregoing division, as long as the corresponding functions can be implemented; in addition, the specific names of the functional units are merely for ease of distinguishing, and are not intended to limit the protection scope of the embodiments of the present disclosure.

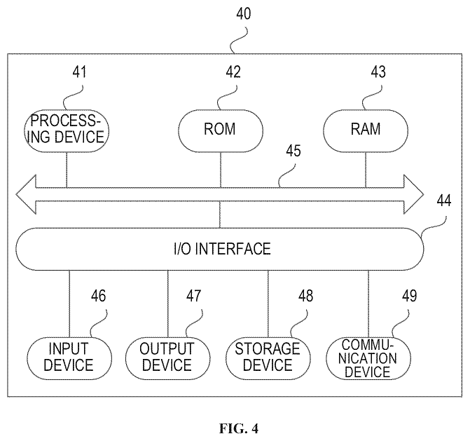

FIG. 4 is a schematic structural diagram of a computer device according to an embodiment of the present disclosure. Reference is made below to FIG. 4, which illustrates a schematic diagram of a structure of a computer device (e.g., a terminal device or a server in FIG. 4) 40 suitable for use in realizing embodiments of the present disclosure. The terminal device in the embodiments of the present disclosure may include, but is not limited to, mobile terminals such as cell phones, laptop computers, digital broadcast receivers, PDAs (personal digital assistants), PADs (tablet computers), PMPs (portable multimedia players), in-vehicle terminals (e.g., vehicle navigation terminals), and the like, and fixed terminals such as digital TVs, desktop computers, and the like. The computer device illustrated in FIG. 4 is merely an example and should not impose any limitation on the functionality and scope of use of embodiments of the present disclosure.

As shown in FIG. 4, the computer device 40 may include a processing device (for example, a central processing unit, a graphics processor, etc.) 41, which may perform various appropriate actions and processes in accordance with a program stored in a read-only memory (ROM) 42 or loaded from a storage device 48 into a random access memory (RAM) 43. Also stored in the RAM 43 are various programs and data necessary for the operation of the computer device 40. The processing device 41, the ROM 42, and the RAM 43 are connected to each other via a bus 45. An edit/output (I/O) interface 44 is also connected to the bus 45.

Generally, the following devices may be connected to the I/O interface 44: an input device 46 including, for example, a touch screen, a touchpad, a keyboard, a mouse, a camera, a microphone, an accelerometer, a gyroscope, etc.; an output device 47 including, for example, a liquid crystal display (LCD), a speaker, a vibrator, etc.; the storage device 48 including, for example, a magnetic tape, a hard disk, etc.; and a communication device 49. The communication device 49 may allow the computer device 40 to communicate wirelessly or wired with other devices to exchange data. Although FIG. 4 illustrates the computer device 40 having various devices, it should be understood that it is not required to implement or have all illustrated devices. More or fewer devices may alternatively be implemented or provided.

In particular, according to an embodiment of the present disclosure, the process described above with reference to the flowchart may be implemented as a computer software program. For example, embodiments of the present disclosure include a computer program product including a computer program embodied on a non-transitory computer readable medium, the computer program including program code for performing the method shown in the flowchart. In such embodiments, the computer program may be downloaded and installed from the network through the communication device 49, or installed from the storage device 48, or from the ROM 42. When the computer program is executed by the processing apparatus 41, the foregoing functions defined in the method of the embodiments of the present disclosure are performed.

The names of messages or information exchanged between the plurality of devices in embodiments of the present disclosure are for illustrative purposes only and are not intended to limit the scope of such messages or information.

The computer device provided by the embodiments of the present disclosure and the method of picture display provided in the foregoing embodiments belong to the same inventive concept, and technical details not described in detail in this embodiment may refer to the foregoing embodiments, and this embodiment has the same beneficial effects as the foregoing embodiments.

An embodiment of the present disclosure provides a computer storage medium having a computer program stored thereon, the program, when executed by a processor, implements the method of picture display provided in the foregoing embodiments.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, apparatus, or appliance, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing.

In the present disclosure, a computer-readable storage medium may be any tangible medium containing or storing a program that may be used by or in connection with an instruction execution system, apparatus, or appliance. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including, but not limited to: wires, optical cables, RF (radio frequency), and the like, or any suitable combination of the foregoing.

In some implementations, the client, server may communicate using any currently known or future developed network protocol, such as HTTP (HyperText Transfer Protocol), and may be interconnected with any form or medium of digital data communication (e.g., a communication network). Examples of communication networks include local region networks (“LANs”), wide region networks (“WANs”), internets (e.g., the Internet), and peer-to-peer networks (e.g., ad hoc peer-to-peer networks), as well as any currently known or future developed networks.

The computer-readable medium described above may be included in the foregoing computer device; or may exist alone or in the computer device.

The computer readable medium carries one or more programs, and when the one or more programs are executed by the computer device, the computer device executes the method of picture display provided in the foregoing embodiments.

Computer program code for performing the operations of the present disclosure may be written in one or more programming languages, including, but not limited to, object oriented programming languages such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local region network (LAN) or a wide region network (WAN), or may be connected to an external computer (e.g., connected through the Internet using an Internet service provider).

The flowcharts and block diagrams in the figures illustrate architecture, function, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the occludes may also occur in a different order than that illustrated in the figures. For example, two consecutively represented occludes may actually be performed substantially in parallel, which may sometimes be performed in the reverse order, depending on the functionality involved. It is also noted that each block in the block diagrams and/or flowcharts, as well as combinations of occludes in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. A name of the unit does not, in certain circumstances, constitute a limitation on the unit itself; for example, the first obtaining unit may be further described as “obtaining at least two units of Internet Protocol addresses”.

The functions described above may be performed, at least in part, by one or more hardware logic components. For example, without limitation, example types of hardware logic components that may be used include: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

The above description is merely an illustration of the preferred embodiments of the present disclosure and the principles of the applied technology. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this should not be understood to require that these operations be performed in the particular order shown or in sequential order. In certain circumstances, multitasking and parallel processing may be advantageous. Likewise, while details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely example forms of implementing the claims.

1. A method of picture display, comprising:
displaying, in response to a video playback instruction, a video streaming picture in a video playback page;
determining, in response to an invoking instruction of an application panel, a first display region and a second display region on the video playback page, wherein the first display region is configured to display the application panel, the second display region is configured to display a key picture region within the video streaming picture, and the key picture region is a partial image region in the video streaming picture.

2. The method according to claim 1, wherein the step of determining the key picture region within the video streaming picture comprises:
determining a playback scene associated with the video streaming picture, and determining a target object based on the playback scene;
determining, based on a feature recognition result of the target object in the video streaming picture, the partial image region from the video streaming picture as the key picture region.

3. The method according to claim 2, wherein determining the playback scene associated with the video streaming picture, and determining the target object based on the playback scene comprises:
determining a playback scene associated with the video streaming picture based on video attribute information of a video to which the video streaming picture pertains;
determining, in accordance with the playback scene pertaining to a first type of playback scene, a first follow object set with respect to the first type of playback scene as the target object;
determining, in accordance with the playback scene pertaining to a second type of playback scene, a second follow object set with respect to the second type of playback scene as the target object;
wherein the first type of playback scene is different from the second type of playback scene.

4. The method according to claim 2, wherein determining, based on the feature recognition result of the target object in the video streaming picture, the partial image region from the video streaming picture as the key picture region comprises:
performing a feature recognition on the target object in the video streaming picture;
selecting, in accordance with the feature recognition result being that no object feature matching the target object is recognized, a first partial image region from the video streaming picture based on a displayable size of the second display region, and determining the first partial image region as the key picture region;
selecting, in accordance with the feature recognition result being that an object feature matching the target object is recognized, a second partial image region of the target object based on a picture proportion of the target object in the video streaming picture, and determining the second partial image region as the key picture region.

5. The method according to claim 4, wherein selecting the first partial image region from the video streaming picture based on the displayable size of the second display region, and determining the first partial image region as the key picture region comprises:
determining a horizontal central axis of the video streaming picture along a vertical direction of the video playback page;
selecting, in the video streaming picture, the first partial image region with the horizontal central axis as a selected region symmetrical line and with the displayable size as a selected region size, and determining the selected first partial image region as the key picture region.

6. The method according to claim 4, wherein selecting the second partial image region of the target object based on the picture proportion of the target object in the video streaming picture, and determining the second partial image region as the key picture region comprises:
determining an object-to-picture proportion of the target object in the video streaming picture;
determining, in accordance with the object-to-picture proportion being greater than or equal to a first set threshold, a picture region in the video streaming picture that has already displayed in the second display region as the second partial image region of the target object, and determining the second partial image region as the key picture region;
selecting, in accordance with the picture proportion being less than the first set threshold, the second partial image region of the target object based on a reference line set in the video streaming picture and in combination with object position information of the target object, and determining the second partial image region as the key picture region.

7. The method according to claim 6, wherein selecting the second partial image region of the target object based on the reference line set in the video streaming picture and in combination with object position information of the target object comprises:
determining, along a vertical direction of the video playback page, a horizontal line at a distance of a second set threshold from a top border of the video streaming picture, and determining the horizontal line as the reference line;
forming a closed display sub-region with the video streaming picture by the reference line and the top border, and extracting an object top position and an object center position in the object position information;
determining, in accordance with the object top position being within the display sub-region, the picture region as the second partial image region of the target object; otherwise, selecting, in the video streaming picture, the second partial image region of the target object with the object center position as a selected region center point and with the displayable size as a selected region size.

8. (canceled)

9. A computer device, wherein the computer device comprises:
one or more processors; a storage device for storing one or more programs,
when the one or more programs are executed by the one or more processors, the one or more processors are caused to implement operations comprising:
displaying, in response to a video playback instruction, a video streaming picture in a video playback page;
determining, in response to an invoking instruction of an application panel, a first display region and a second display region on the video playback page, wherein the first display region is configured to display the application panel, the second display region is configured to display a key picture region within the video streaming picture, and the key picture region is a partial image region in the video streaming picture.

10. A non-transitory computer-readable storage medium having a computer program stored thereon, which, when executed by a processor, implements operations comprising:
displaying, in response to a video playback instruction, a video streaming picture in a video playback page;
determining, in response to an invoking instruction of an application panel, a first display region and a second display region on the video playback page, wherein the first display region is configured to display the application panel, the second display region is configured to display a key picture region within the video streaming picture, and the key picture region is a partial image region in the video streaming picture.

11. The computer device according to claim 9, wherein the step of determining the key picture region within the video streaming picture comprises:
determining a playback scene associated with the video streaming picture, and determining a target object based on the playback scene;
determining, based on a feature recognition result of the target object in the video streaming picture, the partial image region from the video streaming picture as the key picture region.

12. The computer device according to claim 11, wherein determining the playback scene associated with the video streaming picture, and determining the target object based on the playback scene comprises:
determining a playback scene associated with the video streaming picture based on video attribute information of a video to which the video streaming picture pertains;
determining, in accordance with the playback scene pertaining to a first type of playback scene, a first follow object set with respect to the first type of playback scene as the target object;
determining, in accordance with the playback scene pertaining to a second type of playback scene, a second follow object set with respect to the second type of playback scene as the target object;
wherein the first type of playback scene is different from the second type of playback scene.

13. The computer device according to claim 11, wherein determining, based on the feature recognition result of the target object in the video streaming picture, the partial image region from the video streaming picture as the key picture region comprises:
performing a feature recognition on the target object in the video streaming picture;
selecting, in accordance with the feature recognition result being that no object feature matching the target object is recognized, a first partial image region from the video streaming picture based on a displayable size of the second display region, and determining the first partial image region as the key picture region;
selecting, in accordance with the feature recognition result being that an object feature matching the target object is recognized, a second partial image region of the target object based on a picture proportion of the target object in the video streaming picture, and determining the second partial image region as the key picture region.

14. The computer device according to claim 13, wherein selecting the first partial image region from the video streaming picture based on the displayable size of the second display region, and determining the first partial image region as the key picture region comprises:
determining a horizontal central axis of the video streaming picture along a vertical direction of the video playback page;
selecting, in the video streaming picture, the first partial image region with the horizontal central axis as a selected region symmetrical line and with the displayable size as a selected region size, and determining the selected first partial image region as the key picture region.

15. The computer device according to claim 13, wherein selecting the second partial image region of the target object based on the picture proportion of the target object in the video streaming picture, and determining the second partial image region as the key picture region comprises:
determining an object-to-picture proportion of the target object in the video streaming picture;
determining, in accordance with the object-to-picture proportion being greater than or equal to a first set threshold, a picture region in the video streaming picture that has already displayed in the second display region as the second partial image region of the target object, and determining the second partial image region as the key picture region;
selecting, in accordance with the picture proportion being less than the first set threshold, the second partial image region of the target object based on a reference line set in the video streaming picture and in combination with object position information of the target object, and determining the second partial image region as the key picture region.

16. The computer device according to claim 15, wherein selecting the second partial image region of the target object based on the reference line set in the video streaming picture and in combination with object position information of the target object comprises:
determining, along a vertical direction of the video playback page, a horizontal line at a distance of a second set threshold from a top border of the video streaming picture, and determining the horizontal line as the reference line;
forming a closed display sub-region with the video streaming picture by the reference line and the top border, and extracting an object top position and an object center position in the object position information;
determining, in accordance with the object top position being within the display sub-region, the picture region as the second partial image region of the target object; otherwise,
selecting, in the video streaming picture, the second partial image region of the target object with the object center position as a selected region center point and with the displayable size as a selected region size.

17. The non-transitory computer-readable storage medium according to claim 10, wherein the step of determining the key picture region within the video streaming picture comprises:
determining a playback scene associated with the video streaming picture, and determining a target object based on the playback scene;
determining, based on a feature recognition result of the target object in the video streaming picture, the partial image region from the video streaming picture as the key picture region.

18. The non-transitory computer-readable storage medium according to claim 17, wherein determining the playback scene associated with the video streaming picture, and determining the target object based on the playback scene comprises:
determining a playback scene associated with the video streaming picture based on video attribute information of a video to which the video streaming picture pertains;
determining, in accordance with the playback scene pertaining to a first type of playback scene, a first follow object set with respect to the first type of playback scene as the target object;
determining, in accordance with the playback scene pertaining to a second type of playback scene, a second follow object set with respect to the second type of playback scene as the target object;
wherein the first type of playback scene is different from the second type of playback scene.

19. The non-transitory computer-readable storage medium according to claim 17, wherein determining, based on the feature recognition result of the target object in the video streaming picture, the partial image region from the video streaming picture as the key picture region comprises:
performing a feature recognition on the target object in the video streaming picture;
selecting, in accordance with the feature recognition result being that no object feature matching the target object is recognized, a first partial image region from the video streaming picture based on a displayable size of the second display region, and determining the first partial image region as the key picture region;
selecting, in accordance with the feature recognition result being that an object feature matching the target object is recognized, a second partial image region of the target object based on a picture proportion of the target object in the video streaming picture, and determining the second partial image region as the key picture region.

20. The non-transitory computer-readable storage medium according to claim 19, wherein selecting the first partial image region from the video streaming picture based on the displayable size of the second display region, and determining the first partial image region as the key picture region comprises:
determining a horizontal central axis of the video streaming picture along a vertical direction of the video playback page;
selecting, in the video streaming picture, the first partial image region with the horizontal central axis as a selected region symmetrical line and with the displayable size as a selected region size, and determining the selected first partial image region as the key picture region.

21. The non-transitory computer-readable storage medium according to claim 19, wherein selecting the second partial image region of the target object based on the picture proportion of the target object in the video streaming picture, and determining the second partial image region as the key picture region comprises:
determining an object-to-picture proportion of the target object in the video streaming picture;
determining, in accordance with the object-to-picture proportion being greater than or equal to a first set threshold, a picture region in the video streaming picture that has already displayed in the second display region as the second partial image region of the target object, and determining the second partial image region as the key picture region;
selecting, in accordance with the picture proportion being less than the first set threshold, the second partial image region of the target object based on a reference line set in the video streaming picture and in combination with object position information of the target object, and determining the second partial image region as the key picture region.
